(19) United States
(12) Patent Application Publication
(10) Pub. No.: US 2012/0164292 A1
(43) Pub. Date: Jun. 28, 2012

(54) Image display for applying a decoration

(76) Inventor: Ed Lipman, Willowbrook, IL (US)

(21) Appl. No.: 13/374,244

(22) Filed: Dec. 16, 2011

Related U.S. Application Data
(60) Provisional application No. 61/459,761, filed on Dec. 17, 2010.

(51) Int. Cl. A23G 3/28; G03B 21/26; A23P 1/08

(52) U.S. Cl. 426/383; 353/28; 118/14

(57) ABSTRACT

A method and apparatus for applying an image, such as a decoration, to a surface of a food item, such as a cake or other similar item. An input image is selected from a source of images. The input image can be displayed and then transferred, such as through a lens to form an output image. The output image can be projected onto the food item and traced into a decoration.

The entire disclosure of U.S. Provisional Patent Application 61/459,761, filed on 17 Dec. 2010, to which a priority benefit is claimed by this U.S. Patent Application under Title 35, United States Code, Section 119 and/or 120, including the entire teachings are incorporated, by reference, into this specification. This U.S. Patent Application claims the priority benefit of U.S. Provisional Patent Application 61/459,761, filed on 17 Dec. 2010.

### BACKGROUND OF THE INVENTION

1. Field of the Invention

This invention relates to an apparatus and method for applying an image, such as a decoration, to a surface of a food item, such as a cake or other similar dessert food.

2. Discussion of Related Art

There are many known devices and methods for applying decorations, such as icing decorations, to a cake or other dessert food. Some known systems use mechanical devices to apply an image to a food item to form a stylized decoration on a surface of the food item. Some known mechanical devices are operated by control systems that deliver an output as a function of a given input. For example, traveling arms or other mechanical devices can be moved and operated in a controlled manner, based upon a set of computer inputs or programs.

In some known devices, a computer stores different images that can be sent as an input to a control system or other mechanical device, to deliver or apply one or more images to the surface of a food item. In other known devices, an image can be overlaid, projected onto or displayed upon the surface of the food item, so that a user can apply icing or other decorative items to the surface of the food item, which results in a decorated food surface, such as a cake with a word phrase and/or other image decoration.

### INCORPORATION BY REFERENCE

The entire teachings of each and every one of the following United States Patent documents are incorporated into this Specification by reference to U.S. Pat. Nos. 2,387,021; 3,044,351; 3,402,635; 4,416,075; 4,531,292; 5,505,775; 7,012,712; 7,286,258; Des. 179,670; Des. 190,103; Des. 199,337; Des. 210,102; and Des. 222,705; U.S. Patent Application Publications US 2005/0088693; US 2006/0087686; US 2010/0080876; and US 2010/0104713; and PCT International Publication WO 02/071307 A1.

### BRIEF DESCRIPTION OF THE DRAWINGS

FIG. 1 is an isometric view of an image display apparatus, according to one embodiment of this invention;

FIG. 2 is a diagrammatic view of an image display apparatus, according to another embodiment of this invention;

FIG. 3 is a diagrammatic view of an image display apparatus, according to still another embodiment of this invention;

FIG. 4 is a perspective view of an image display apparatus, according to another embodiment of this invention;

FIG. 5 is a front perspective view of the image display apparatus, as shown in FIG. 4;

FIG. 6 is a bottom perspective view of the image display apparatus, as shown in FIG. 4;

FIG. 7 is a bottom perspective view, rotated with respect to the view shown in FIG. 6, of the image display apparatus, as shown in FIG. 4;

FIG. 8 is a rear perspective view with a cutaway section of the housing, of the image display apparatus, as shown in FIG. 4;

FIG. 9 is perspective rear view, slightly rotated from the position shown in FIG. 8, with a cutaway section of the housing, of the image display apparatus, as shown in FIG. 4;

FIG. 10 is a bottom perspective view, with a cutaway section of the housing, of the image display apparatus, as shown in FIG. 4;

FIG. 11 is a front perspective view of an image display apparatus, in an exploded view with the housing totally removed, of an image display apparatus, according to one embodiment of this invention;

FIG. 12 is a front perspective view of a display, according to one embodiment of this invention;

FIG. 13 is a perspective view, in a different orientation, of the display as shown in FIG. 12;

FIG. 14 is a front perspective view of an image display apparatus, according to one embodiment of this invention;

FIG. 15 is a rear perspective view of the image display apparatus, as shown in FIG. 14;

FIGS. 16-18 are front, side and top views, respectively, of the image display apparatus, as shown in FIG. 14;

FIGS. 19 and 20 each shows a rear perspective view, each in a slightly different orientation, with a cutaway section of the housing, of an image display apparatus, according to another embodiment of this invention;

FIGS. 21-23 show side, front and top views, respectively, of the image display apparatus, as shown in FIGS. 19 and 20;

FIG. 24 shows a front perspective view of an image display apparatus, in a folded position, according to one embodiment of this invention; and

FIGS. 25-27 show front, side and top views, respectively, of the folded image display apparatus, as shown in FIG. 24.

### DETAILED DESCRIPTION OF THE INVENTION

Many of the technical features and/or elements of this invention are identical or similar to those taught by U.S. Pat. Nos. 2,387,021; 3,044,351; 3,402,635; 4,416,075; 4,531,292; 5,505,775; 7,012,712; 7,286,258; Des. 179,670; Des. 190,103; Des. 199,337; Des. 210,102; and Des. 222,705; U.S. Patent Application Publications US 2005/0088693; US 2006/0087686; US 2010/0080876; and US 2010/0104713; and PCT International Publication WO 02/071307 A1, which are incorporated into and made a part of this Specification.

The apparatus and method of this invention can be used to apply an image to the surface of a food item, such as icing on a cake. For example, it is possible to generate and apply a birthday greeting, another suitable message and/or an electronically generated image, such as a photograph of a person, an animal and/or another object, on the food item. An input image can be selected from an electronic database and/or from a library of physical images or hard copies, and applied to the surface of the food item, to create an output image, such as the photograph or other generated image, on the surface of the food item. With the apparatus and the method according to this invention, for example, it is possible to select a cartoon character from a comic book or a coloring book and then apply the cartoon character to a birthday cake. It is also possible to select a photograph of a person or other object and apply the corresponding image to a birthday cake.

The output image can be applied by a person, such as by tracing using hands and fingers, and/or by a mechanical device or system, such as a controlled mechanical system that includes an operated mover and a nozzle or another suitable flow device through which a food item, such as icing, can flow, pass and/or disperse in a fluidic manner, a spray manner and/or another suitable movable manner.

As used throughout the specification and claims of this patent application, the term food item is intended to be interchangeable with and relate to any one or more of the terms foodstuff, birthday cake, icing on a cake and/or any other suitable similar food and/or item that can accept icing and or any other suitable decorative item, for example.

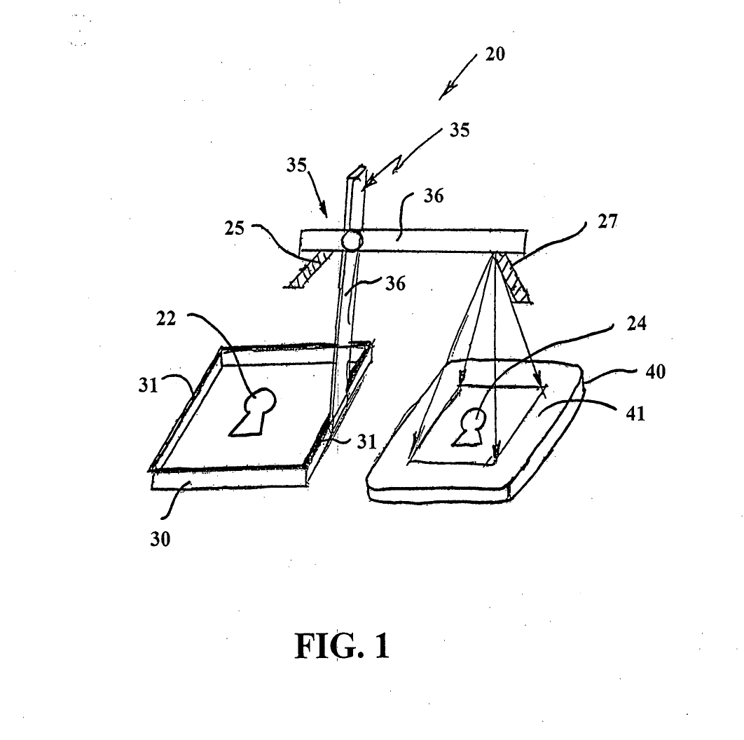

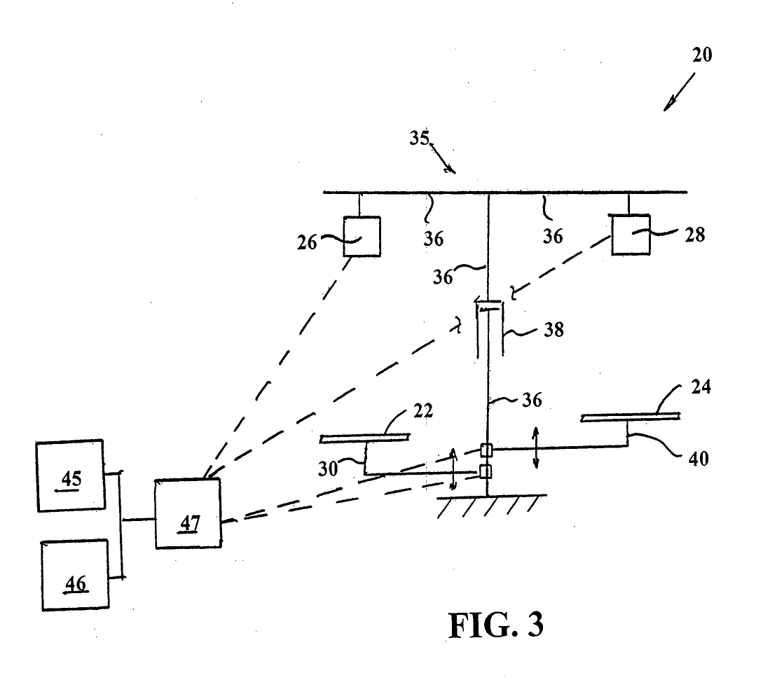

FIG. 1 shows one embodiment of display apparatus 20, according to this invention, which can be used to generate, display, sense, input, transfer and/or apply image 22 directly or indirectly positioned or located at holder 30 to or into image 24 directly or indirectly positioned or located on surface 41, such as an external surface, of object 40. As used throughout the specification and the claims of this patent application, image 22 is intended to relate to and be interchangeable with an input image that can be sensed, input and/or transferred, such as electronically, mechanically and/or optically, from holder 30, database 45 and/or library 46, such as shown in FIG. 3. As used throughout the claims and specification of this patent application, image 24 is intended to relate to and be interchangeable with an output image that can be transferred, output and/or displayed, such as electronically, mechanically and/or optically, from image 22, either as the same image or as a different or distorted image.

In some embodiments according to this invention, image 24 can be identical to image 22 or can be different from image 22. In other embodiments of this invention, image 22 can have the same shape but different dimensions as image 24. In still other embodiments of this invention, image 24 can be modified, distorted and/or manipulated to be different from image 22. Image 22 can be directly or indirectly transferred or converted into image 24. For example, image 22 can be sensed and/or identified and then modified as a function of different decisions made by a processor, a computer, a control system and/or a human. In some embodiments according to this invention, image 22 can be distorted for fun or play purposes, similar to the manner in which an image can be distorted through trick or play mirrors.

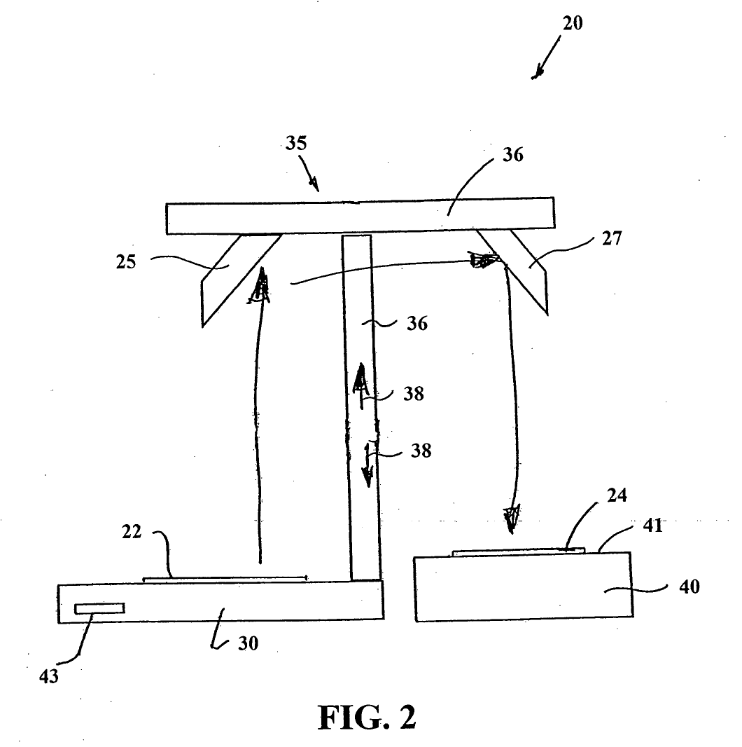

As shown in FIGS. 1-3, structure 35 can be secured or otherwise adjustably connected to holder 30. In some embodiments according to this invention, such as shown in FIGS. 1 and 2, structure 35 includes support arms 36 or other similar structures or structural elements that can be used to structurally support and/or adjustably move reflector or mirror 25 and/or reflector or mirror 27 and then fix or otherwise secure the position of mirror 25 and/or mirror 27 with respect to image 22 and/or image 24. In other embodiments according to this invention, structure 35 may have limited adjustable movement or no adjustable movement and may thereby fix the position of mirror 25 and/or mirror 27 with respect to image 22 and/or image 24, but any one or more of mirror 25, mirror 27, the position of image 22 and/or the position of image 24 can be adjusted or otherwise moved with respect to each other and/or with respect to holder 30, for example: The adjustability feature of structure 35, mirror 25, mirror 27, image 22 and/or image 24 can be used to move, adjust, focus or otherwise vary image 24, particularly as compared to image 22, for example as it appears on surface 41 of object 40.

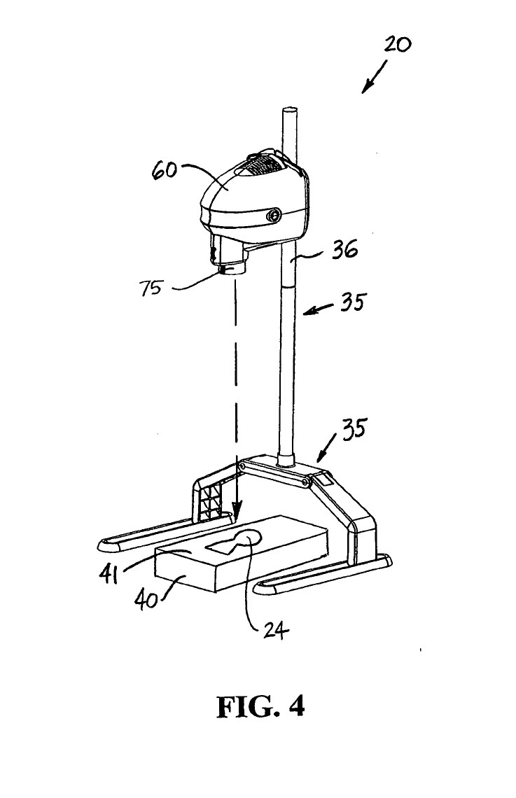

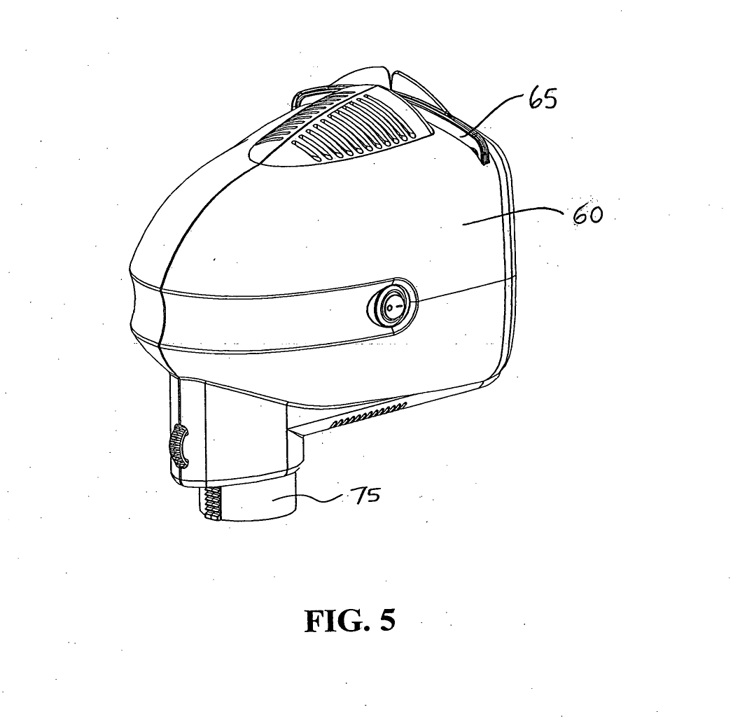

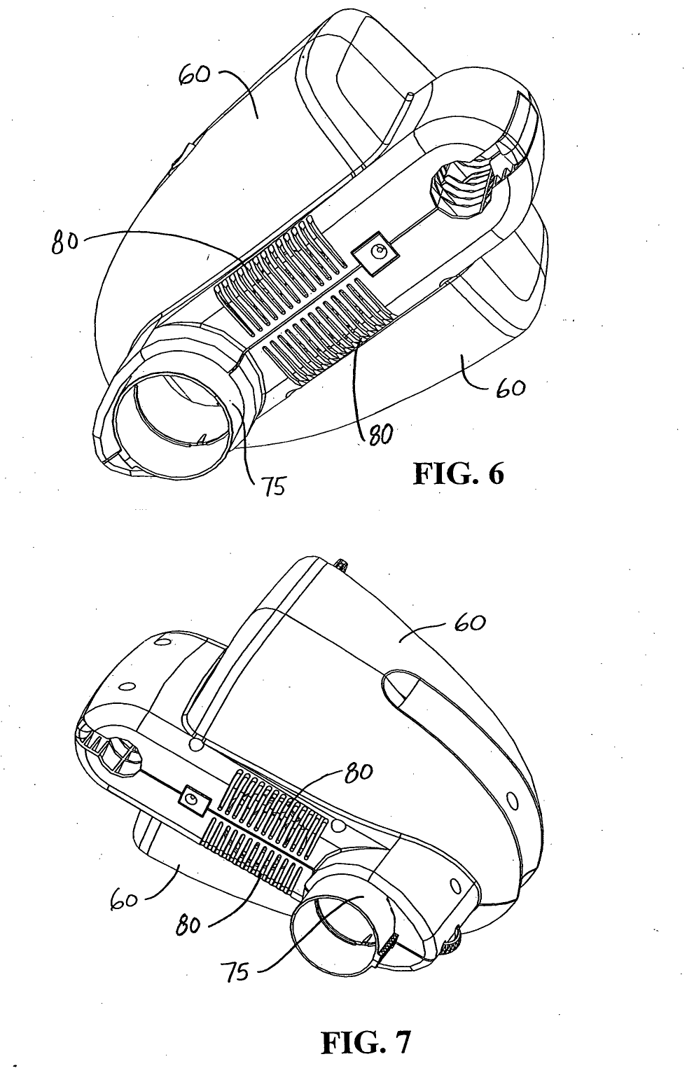

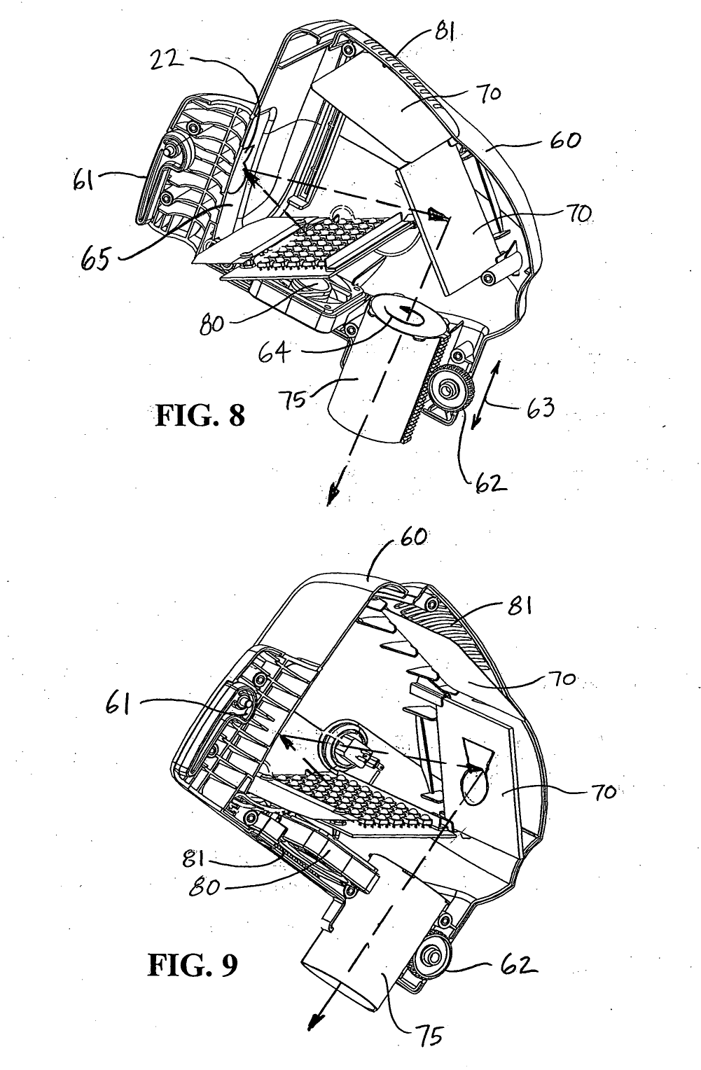

In the embodiments shown in FIGS. 4-11, for example, structure 35 has a different configuration than structure 35 shown in FIGS. 1 and 2. As shown in FIG. 4, housing 60 is adjustably mounted with respect to structure 35 and/or support arm 36, which is shown by example as an elongated rod but could also be any other suitable structure that allows housing 60 to mount and/or move with respect to structure 35 and/or support arm 36. For example, FIGS. 8 and 9 show lock 61 that can be operated and/or engaged to allow housing 60 to move with respect to structure 35 and/or support arm 36 and then to be locked in a desired position. Any other suitable lock or securing element can be used to fix the relative position of housing 60 with respect to structure 35 and/or any other suitable structural element.

Mirror 25 and/or mirror 27 can be replaced by or supplemented with any other lens 26, 28, such as shown in FIG. 3, reflector, or other similar suitable device capable of sensing, detecting, manipulating, computing, projecting and/or displaying image 24 on surface 41 or any other suitable object or surface. Display apparatus 20 of this invention can have greater than two mirrors or less than two mirrors, depending upon the particular image projection desired.

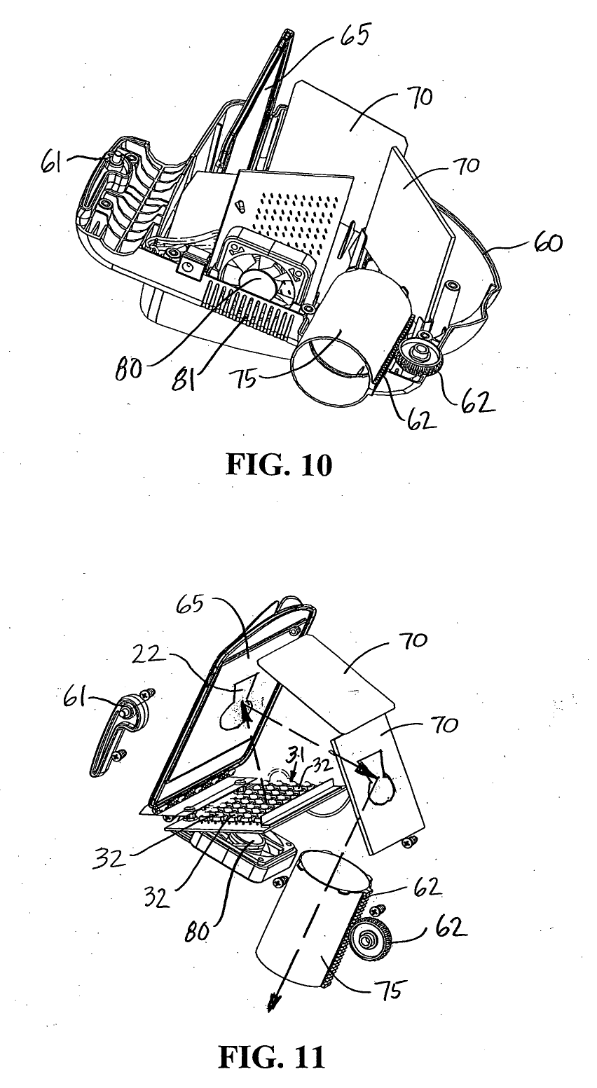

Mirror 25 and/or mirror 27 can also be replaced by or supplemented with reflector 70, for example as shown in FIGS. 10 and 11, and/or any other suitable structure that at least partially reflects light or light rays. Reflector 70 can be constructed of and/or coated with any suitable material and/or substance that at least Partially reflects light or light rays. FIGS. 8 and 9, for example, show two reflectors 70 mounted within housing 60. However, in other embodiments of this invention, more or less than two reflectors 70 can be used to reflect or otherwise transfer or direct light rays.

In some embodiments according to this invention, object 40 comprises a food item, such as a cake or other dessert. In other embodiments according to this invention, object 40 can comprise any other suitable three-dimensional item.

Structure 35, support arm 36, holder 30, mirror 25, mirror 27, housing 60, reflector 70, display 65, lens 75, image 22, image 24 and/or-object 40 can be moved, controlled, positioned, operated and/or manipulated with respect to each other to maintain or vary image 22 as it appears as image 24 on surface 41. In some embodiments according to this invention, such as shown in FIGS. 8-11, lens 75 can be moved, such as vertically and/or rotatably, to differently focus lens 75 and thus produce any desired image 24. For example, FIG. 8 shows arrow 63 indicating vertical movement of lens 75 with respect to housing 60 and/or structure 35, and also shows arrow 64 indicating rotational movement of lens 75 with respect to housing 60 and/or structure 35. Any other suitable structural and/or mechanical and/or electrical and/or magnetic arrangement can be used to vary and/or lock the position of lens 75 with respect to housing 60 and/or structure 35.

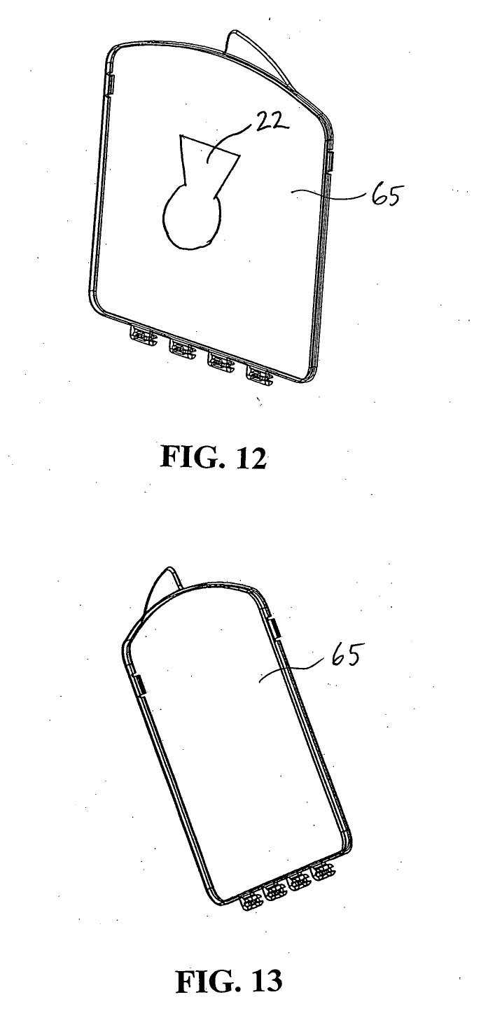

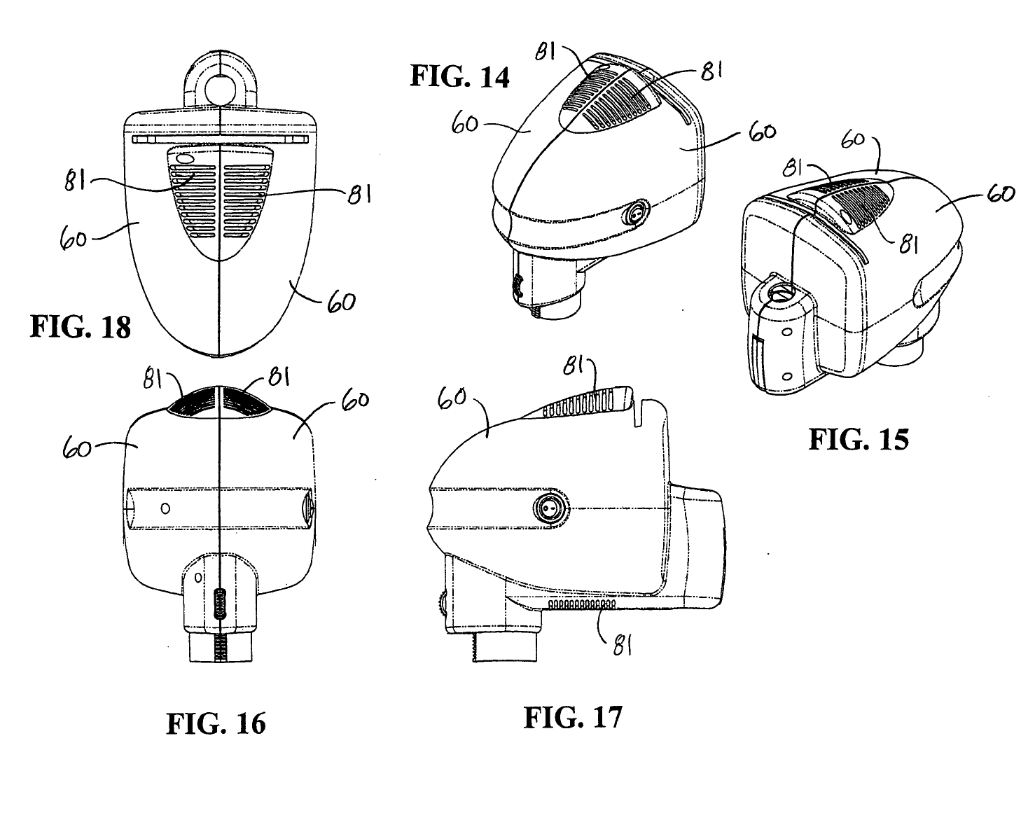

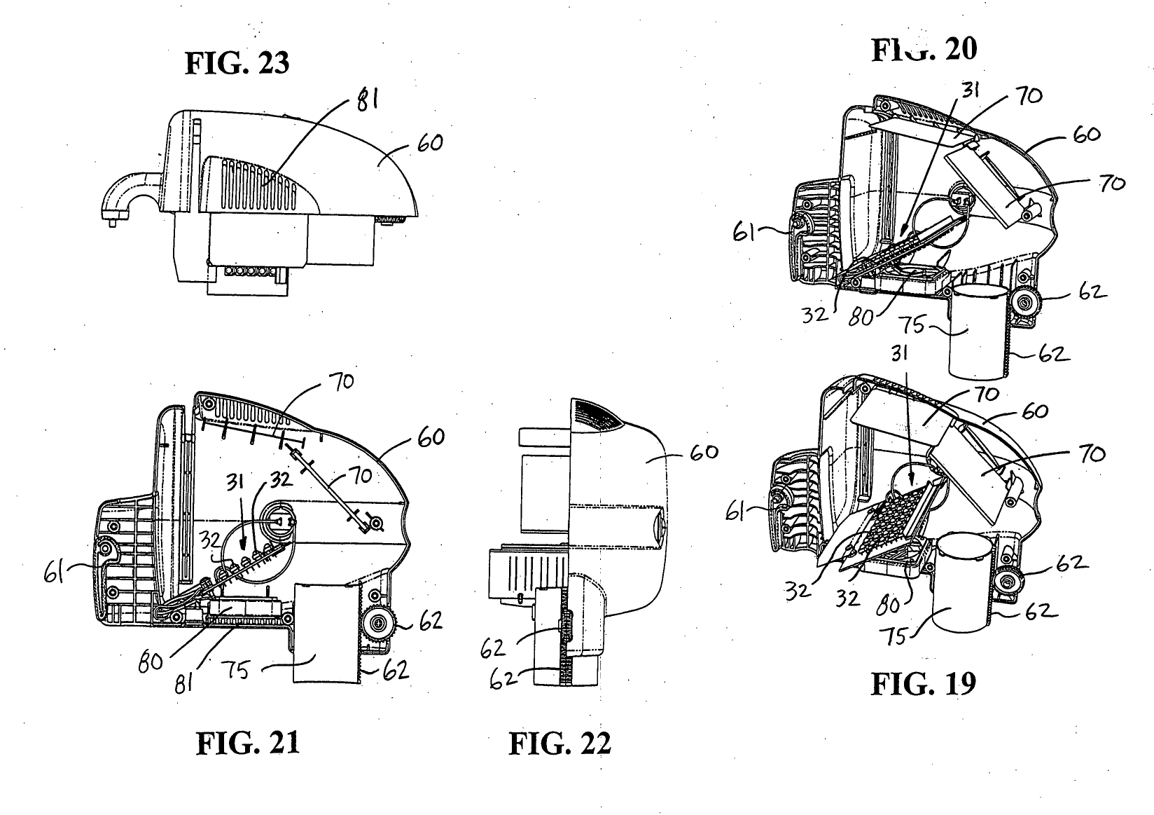

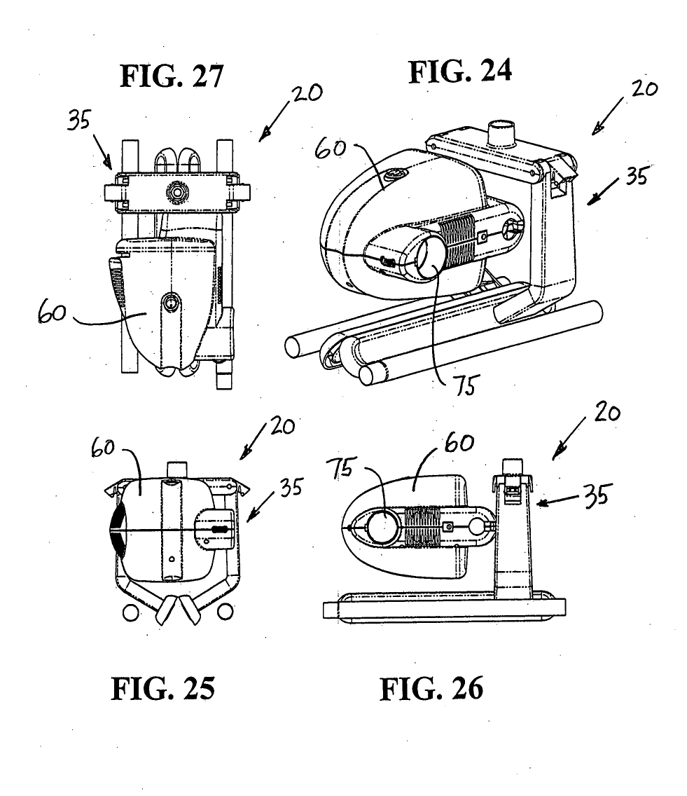

Holder 30 can comprise any suitable structure or device capable of fixing a position of image 22 and/or projecting image 22 away from holder 30. In some embodiments of this invention, holder 30 comprises a translucent or transparent plate, such as a plate surface beneath or under image 22, which may or may not be backlit, such as with a suitable light source 31, which can be natural or artificial. In other embodiments according to this invention, such as shown in FIGS. 4-27, holder 30 as shown in FIG. 1 can comprise or be replaced with display 65 holding and/or displaying image 22. In some embodiments according to this invention, display 65 comprises a case, a cage and/or any other suitable structure that can be used to hold image 22, particularly when image 22 comprises a hard copy, such as a piece of paper, a photograph and/or another suitable image carrier. FIGS. 12 and 13 show one embodiment of display 65 according to this invention. Any other suitable structural element and/or holder can be used to hold or display image 22. In other embodiments according to this invention, display 65 comprises a computer screen, a flatscreen, a projection screen and/or any other type of surface that can be used to display an electronic image, such as of a photograph or picture, which can be used in place of or in combination with display 65 as shown in FIGS. 12 and 13.

Once image 22 is fixed with respect to holder 30 and/or display 65, a position of structure 35, support arm 36, holder 30, housing 60, display 65, reflector 70, lens 75, mirror 25, mirror 27, image 22, image 24 and/or object 40 can be adjusted to vary or focus image 24, as derived from image 22, such as on surface 41 of object 40. For example, surface 41 may comprise icing of a cake and decorative icing or any other suitable decorative item can be applied to surface 41, such as by tracing or otherwise following the shape of image 24. Display apparatus 20 of this invention can be used to decorate a cake or other suitable food item.

In some embodiments of this invention, image 22 can be communicated, either wired or wireless, as indicated by the dashed lines in FIG. 3, displayed and/or projected from computer 47, such as shown in FIG. 3, or from or by another suitable electronic device. For example, data port 43 and/or a USB drive, such as shown in FIG. 2, can be plugged into a base portion of holder 30 and/or housing 60, to electrically communicate, either wired or wireless, with a computer or other control device through which image 22 can be selected or otherwise produced or derived. In other embodiments according to this invention, image 22 can be communicated, such as by cable, wire, optic fiber, in a wireless manner, and/or by any other suitable communication device, and possibly received by a projector, a flatscreen, a computer screen or other image producing device that results in a desired or selected image 24 on surface 41 of object 40.

In other embodiments according to this invention, image 22 can be displayed on paper, such as printer paper or transparency paper, and image 22 can be projected or otherwise transmitted away from the paper and/or holder 30 and/or display 60. As shown in FIG. 1, LED lighting or another suitable light source 31 can be recessed or otherwise positioned or arranged to light or illuminate image 22, such as for better visual display.

In some embodiments according to this invention, image 22 can be displayed and/or image 24 can be generated as a direct output image to be displayed on object 40. In some embodiments of this invention, light source 31 illuminates or lights image 22, so that image 22 can be projected or transferred from housing 60 and/or holder 30 to form output image 24. Light source 31 may comprise any suitable light source that directs light or light rays at or upon image 22 and carries or reflects image 22 through housing 60 and then through lens 75 and onto external surface 41 of object 40.

As shown in FIG. 11, for example, in some embodiments of this invention, a method for applying image 24 to object 40 includes selecting image 22 as an input image, which can be done manually or automatically with a computer and database 45, and then transferring image 22 through housing 60, through lens 75 and then at object 40, such as shown in FIG. 4, to display image 24. In some embodiments of this invention, image 22 or another suitable input image can be stored in a source, such as database 45 and/or library 46 which can be an electronic database and/or a physical or hard copy database and/or library. As shown in FIG. 11 for example, image 22 is displayed or appears on display 65 which can be fixed or detachably secured or mounted with respect to housing 60 and/or structure 35. FIG. 11 shows display 65 as a cage and/or a case type structure that can be detachably removed from or with respect to housing 60. When detached from housing 60, display 65 can be opened and image 22, such as a photograph or a cartoon or a greeting, can be inserted into display 65, which can then be closed to fix the position of image 22 with respect to display 65.

FIGS. 9 and 11 show how light source 31 transfers image 22 from display 65 through or across each reflector 70 and then into and through lens 75 and then directs image 24 at or on object 40. One or more reflectors 70 can be positioned within housing 60 or otherwise used to reflect the light that represents image 22 being transferred through housing 60 and/or any other suitable structure. Lens 75 can be vertically adjusted, rotationally adjusted and/or otherwise adjusted to vary or not vary image 22 as it is converted and/or transferred into image 24.

As shown in FIGS. 4-11, for example, according to some embodiments of this invention, light source 31 comprises an array of LED lights 32. In some embodiments of this invention, LED lights 32 comprise very bright, relatively bright and/or superbright LED lights. Depending upon the level of light surrounding housing 60, light source 31 and/or LED lights 32 may need to be brighter or dimmer, depending upon the desired application.

As shown in FIGS. 8-11, fan 80 is mounted to direct air or air flow at or through housing 60, for example to cool the corresponding materials and reduce heat generated by light source 31. In some embodiments of this invention, housing 60 comprises slots or vents 81 that allow proper airflow through housing 60, for example. In other embodiments according to this invention, fan 80 may not be necessary.

In some embodiments of this invention, controlled mechanical system 50, such as shown in FIG. 3, can be used to receive an input signal and in response, such as through a controller or other programmed device, operate a mover to apply a decorator, such as icing for a cake, to exposed surface 41 of object 40.

FIG. 2 shows another embodiment of display apparatus 20, according to this invention. The up and down vertical arrows 38 on structure 35, such as shown in FIG. 2, are intended to indicate or represent a mover, such as a mechanical, electrical, magnetic and/or electromechanical device that can be operated to change or vary the vertical height of structure 35, for example, that can be used to vary the resulting image 24 on surface 41.

Many of the features and/or elements taught by U.S. Pat. Nos. 2,387,021; 3,044,351; 3,402,635; 4,416,075; 4,531,292; 5,505,775; 7,012,712; 7,286,258; Des. 179,670; Des. 190,103; Des. 199,337; Des. 210,102; and Des. 222,705; U.S. Patent Application Publications US 2005/0088693; US 2006/0087686; US 2010/0080876; and US 2010/0104713; and PCT International Publication WO 02/071307 A1; can be used in place of or in combination with similar elements described, without departing from the results that can be obtained by or with display apparatus 20 of this invention.

While in the foregoing detailed description this invention has been described in relation to certain preferred embodiments thereof, and many details have been set forth for purposes of illustration, it will be apparent to those skilled in the art that this invention is susceptible to additional embodiments and that certain of the details described herein can be varied considerably without departing from the basic principles of this invention.

The entire disclosure of United States Provisional Patent Application having Ser. No. 61/459,761, filed on 17 Dec. 2010, is incorporated into this specification and patent application by reference thereto.

What is claimed is:

1. A method for applying an image to a food item, the method comprising:
selecting an input image from a source of images;
displaying the input image on a display mounted with respect to a housing;
transferring the input image from the display and through a lens and forming an output image; and
projecting the output image onto the food item.

2. A method according to claim 1, wherein the input image is reflected from a reflector within the housing before the input image is transferred through the lens.

3. A method according to claim 1, wherein a light source transfers the input image from the housing.

4. A method according to claim 3, wherein the light source comprises an array of light emitting diodes directing light onto the input image.

5. A method according to claim 1, wherein the lens is adjustable to vary the output image.

6. A method according to claim 1, wherein the images are stored in the source comprising an electronic database or a library of the images.

7. A method according to claim 1, wherein the image comprises an input image retrieved from an electronic database or a library of the images.

8. A method according to claim 1, wherein the output image is applied to an exposed surface of the food item.

9. A method according to claim 1, wherein a controlled mechanical system receives an input signal and operates a mover, and the mover applies a decorator to an exposed surface of the food item and forms an applied image to the exposed surface.

10. A method according to claim 1, wherein the input image is different from the output image.

11. A method according to claim 1, wherein the output image is traceable onto an exposed surface of the food item.

12. An apparatus for applying an image to a food item, the apparatus comprising:
a housing adjustably mounted with respect to the food item, a display mounted with respect to the housing, the display holding an input image, a light source illuminating the input image, the light source mounted with respect to the housing to transfer the input image from the display and through a lens to form an output image; and the lens mounted with respect to the housing and projecting the output image onto the food item.

13. An apparatus according to claim 12, wherein a reflector mounted with respect to the housing reflects the input image and the reflector is aimed to transfer the input image through the lens.

14. An apparatus according to claim 12, wherein the light source comprises an array of light emitting diodes directing light onto the display holding the input image.

15. An apparatus according to Claim. 12, wherein the lens is adjustably mounted with respect to the housing to vary the output image.

16. An apparatus according to claim 12, further comprising an electronic database or a library storing images including the input image.

17. An apparatus according to claim 12, wherein the image comprises an input image retrieved from an electronic database or a library of the. images.

18. An apparatus according to claim 12, further comprising a controlled mechanical system receiving an input signal and operating a mover, and the mover applying a decorator to an exposed surface of the food item and forming an applied image to the exposed surface.

19. An apparatus according to claim 12, wherein the output image is traceable onto an exposed surface of the food item.
